(19) United States
(12) Patent Application Publication
(10) Pub. No.: US 2026/0032420 A1
(43) Pub. Date: Jan. 29, 2026

(54) TERMINAL WITH AN ASSISTANCE MODULE FOR MANAGING TELECOMMUNICATIONS PROFILES STORED IN THE TERMINAL, AND MANAGEMENT METHOD

(71) Applicant: GIESECKE+DEVRIENT MOBILE SECURITY GERMANY GMBH, Munchen (DE)

(72) Inventors: Ulrich HUBER, Munchen (DE); Claus DIETZE, Obersochering (DE)

(21) Appl. No.: 19/139,579

(22) PCT Filed: Dec. 20, 2023
(86) PCT No.: PCT/DE2023/100985

§ 371 Date: Jun. 16, 2025

(30) Foreign Application Priority Data
Dec. 21, 2022 (DE) 10 2022 004 853.1

(51) Int. Cl. H04W 8/18; H04W 4/50; H04W 12/06; H04W 12/72

(52) U.S. Cl. CPC H04W 8/18; H04W 4/50; H04W 12/06; H04W 12/72

(57) ABSTRACT

A terminal includes an embedded identification module designed to perform profile management tasks, allowing a telecommunications profile stored in the embedded identification module to be altered or a new telecommunications profile to be loaded. The embedded identification module features a first assistance module that provides an interface to a remote management unit, and a second assistance module connected to the embedded identification module that offers a second interface to a profile provision entity. Either the first assistance module or the second assistance module is active. The terminal receives command data sets from the remote management unit, which contain profile management actions. The first and second assistance modules work together to execute a profile management action based on predetermined conditions.

The invention relates to the management of telecommunications profiles in terminals which are controllable by means of a data network, having restricted network access or a restricted user interface.

The GSMA (GSM Association) has already standardized architectures for the remote provision of eSIM profiles for end-user devices and for M2M devices. Firstly, provision is made for the set-up of a local profile assistant (LPA) on the user device, which controls the lifecycle of the profile on the device. Loading of an eSIM profile is initiated by a user. The standard for M2M devices is based upon the employment of SMS messages, and requires the integration of participating entities. Neither of these known solutions can be translated to IoT devices, or can only be disadvantageously translated thereto. In general, IoT devices feature only a limited hardware configuration, and have no dedicated user interface.

DE 102021127364 A1 discloses the implementation of a secure connection of an IoT device to a wireless network, wherein the IoT device communicates with an authentication server via an access point, in order to obtain access data for the network.

US 20220295281 A1 describes a system for the reconfiguration of an embedded identification module in a terminal, wherein identification profiles can be delivered from a server to the terminal by means of a remote management unit (“remote IoT manager”).

In the new GSMA standard SGP.31 “eSIM IoT Architecture and Requirements”, Version 1.0, Apr. 19, 2022, an architecture for the remote management of specific telecommunication profiles for IoT devices is described. The new standard is based upon GSMA standard SGP.21 for end-user devices, and incorporates key elements thereof, inter alia the concept of a profile provision entity (SM-DP+). A new feature vis-à-vis the known architecture is the introduction of a remote management unit, which is connected to the IoT device and to the profile provision entity (SM-DP+), and of an assistance module, which can be implemented in two variants. In a first variant, the support module is an element of the IoT device and, in a second variant, the support module is configured in the identification module which is embedded in the IoT terminal. By means of profile management actions, the architecture enables the loading and modification of profiles which are saved in the embedded identification module. Downloading of a telecommunication profile is executed independently of any implementation between the support module and the profile provision entity.

Both implementations have respective advantages and disadvantages. An assistance module is more complex to implement in an IoT terminal than in an embedded identification module, and is comparatively less secure, albeit more efficient and more flexible vis-à-vis the latter.

The object of the invention is the disclosure of a terminal which combines the advantages of both implementations.

This object is fulfilled by a terminal and by a method having the features of the independent claims.

The terminal according to the invention is characterized in that it comprises a first assistance module, which is set up in the embedded identification module, and a second assistance module, which is set up in the terminal itself, wherein, at all times, only one of the two assistance modules is active. Two operating modes are defined by the activity of the first or the second assistance module.

Subdivision into two assistance modules provides an advantage, in that the first assistance module can be adapted to a given situation in a flexible manner. If the remote management unit supports profile status actions only, implementation of the first assistance module in the embedded identification module can be configured in a highly streamlined manner. As profile status actions require only small volumes of data, only limited requirements apply to the performance capability of the first assistance module, in the case of implementation in the embedded identification module.

An embedded identification module equipped with a corresponding first assistance module can be set up in a simple manner by the downloading thereof on a terminal.

One exemplary embodiment of the invention is described in greater detail hereinafter, with reference to the drawing.

In the drawing:

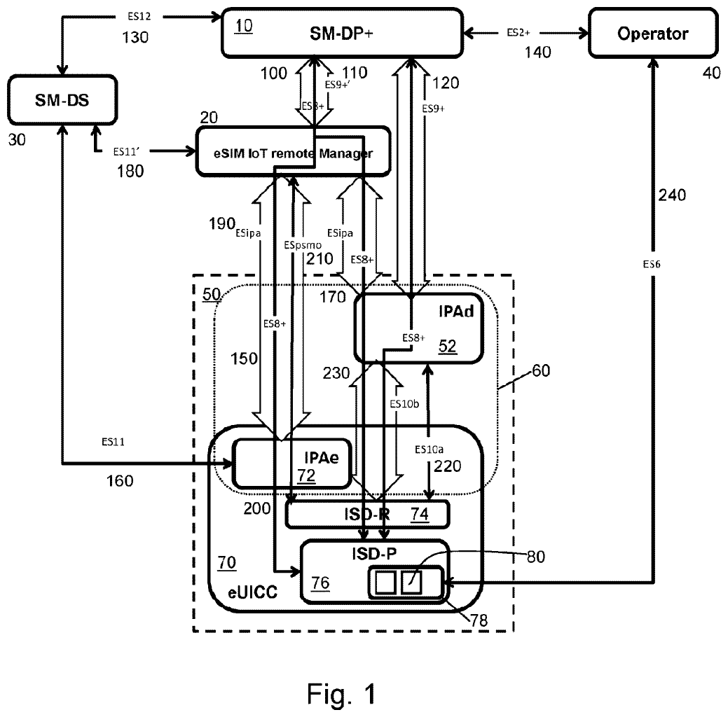

FIG. 1 shows an architecture for the set-up and management of a telecommunications profile, which is saved in an embedded identification module in an IoT terminal;

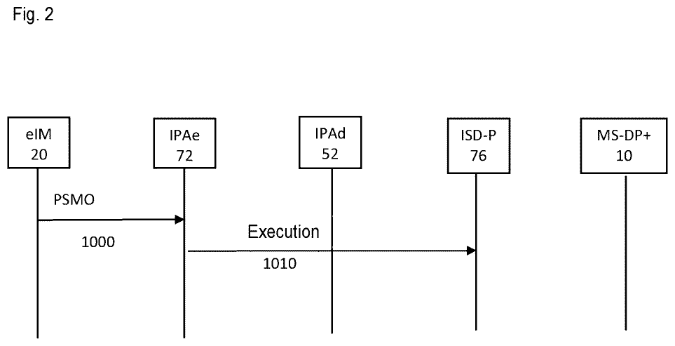

FIG. 2 shows a sequence of a profile status action;

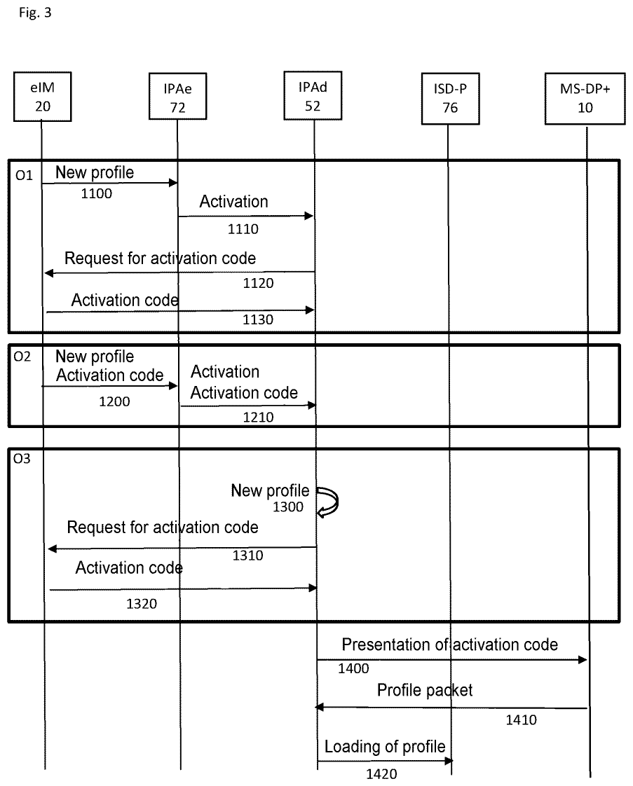

FIG. 3 shows the loading of a profile from a profile provision entity into an embedded identification module.

### DESCRIPTION

FIG. 1 shows an architecture for the set-up and management of a telecommunications profile, which is saved in an embedded identification module in an IoT terminal. This architecture comprises a profile provision entity 10 (Subscription Manager Data Preparation, or SM-DP+for short), a remote management unit 20 (eSIM IoT remote manager, or eIM for short), an intermediate server 30 (Subscription Manager Discovery Server, or SM-DS for short), a network operator 40, and a terminal 50, as represented, for example, in GSMA standard SGP.31-v1.0.

A profile support module 60 comprised of two components 52, 72, and an embedded identification module 70 are situated in the terminal 50. In the embedded identification module 70, a source domain 74 (ISD-R) of a publisher and at least one profile domain 76 (ISD-P) are configured, in a manner which is also known from GSMA standard SGP.31-v1.0. Each profile domain 76 (ISD-P) incorporates a secure domain 78 (MNO-SD) of a network operator 40. In the secure domain 78 (MNO-SD), at least one telecommunications profile 80, also described hereinafter as a “profile” for short, is saved. Components of the architecture represented in FIG. 1 respectively comprise one or more interfaces, via which these components are mutually interconnected by means of data connections and/or data networks, as described in greater detail hereinafter.

The function of the profile provision entity 10 (SM-DP+) is the provision of profile packets containing telecommunications profiles 80 for downloading in a secure manner.

The function of the remote management unit 20 (eIM) is the set-up and management of profiles 80 which are saved in the embedded identification module 70 (eUICC). To this end, the remote management unit 20 (eIM), by means of command data records, controls the loading of profiles 80 in the embedded identification module 70 (eUICC) and the modification of states of saved profiles 80. To this end, command data records incorporate profile management operations, which term can particularly describe loading operations (profile downloads) and profile state management operations (or PSMO for short). Optionally, the remote management unit 20 (eIM) can be designed, in the context of loading processes, to convert profile packets, in order to execute the conversion thereof into a protocol which is required for the employment of an interface, for example a narrowband protocol.

The function of the intermediate server 30 (SM-DS) is the provision of addresses of profile provision entities 10 (SM-DP+) in response to discovery requests generated by connected components 20, 50.

The network operator 40 is, for example, a cellular radio network operator.

The terminal 50 can be, for example, a component of a consumer durable, for example of an automobile or a camera, or an element of a sensor unit. In general, it incorporates no user interface. In particular, the terminal 50 can be an IoT terminal.

The profile support module 60 communicates with the profile provision entity 10 (SM-DP+), the remote management unit 20 (eIM) and the embedded identification module 70 (eUICC), and enables the loading of profiles 80 in the embedded identification module 70 (eUICC), and the modification of the states of loaded profiles 80.

The embedded identification module 70 is embodied, for example, as an eUICC, i.e. in the form of a hardware-and software-based secure HW element which is installed in a terminal 50.

This architecture, and the components thereof, thus correspond to GSMA standard SGP.31-v1.0, or to associated standards.

By way of distinction from the architecture according to GSMA Standard SGP.31-v1.0, in the architecture according to the invention represented in FIG. 1, the profile support module 60 is comprised of two components-a first assistance module 72 (IPAe) and a second assistance module 52 (IPAd). The first assistance module 72 (IPAe) is configured in the embedded identification module 70 (eUICC). The second assistance module 52 (IPAd) is embodied as part of the terminal 50.

Each of the components 10, 20, 30, 40, 50, 52, 70, 72 comprises one or more interfaces, via which the interconnection thereof is enabled by means of data connections and/or data networks which are conventional per se.

The profile provision entity 10 (SM-DP+) provides interfaces 100 (ES8+), 110 (ES9+′), 120 (ES9+), 130 (ES12) and 140 (ES2+) to the remote management unit 20 (eIM), the intermediate server 30 (SM-DS), the second assistance module 52 (IPAd) and the network operator 40. By means of the second assistance module 52 (IPAd), the profile provision entity 10 (SM-DP+) communicates using the protocols and interfaces which are defined in GSMA standard SGP.22. Thus, for the implementation of this architecture, in particular, a profile provision entity 10 (SM-DP+) according to GSSMA standard SGP.22 can be employed, without the necessity for the implementation of a specific communication channel for communication with the second assistance module 52 (IPAd).

The first assistance module 72 (IPAe) provides an external interface 150 (ES8+) to the remote management unit 20, and an external interface 160 (E11) to the intermediate server 30 (SM-DS). An interface 200 to the profile domain 76 (ISD-P) is moreover provided within the embedded identification module 70.

The second assistance module 52 (IPAd) is connected within the terminal 50, via internal interfaces 220, 230, to the embedded identification module 70 (eUICC), and moreover comprises an external side interface 170 (ESipa) to the remote management unit 20 (eIM).

The second assistance module 52 (IPAd) is designed to execute a data exchange with the profile provision entity 10 (SM-DP+), in order to load a new profile 80 into the embedded identification module 70 (eUICC). Communication between the second HW assistance module 52 (IPAd) and the profile provision entity 10 (SM-DP+) is executed by means of a second protocol, preferably by means of the protocol defined in SGP.22.

Via the side interface 170 (ESipa), the second assistance module 52 (IPAd) can request and receive activation codes from the remote management unit 20 (eIM).

The secure domain of the network operator 78 (MNO-SD) in the embedded identification module 70 (eUICC) is further provided, via the terminal 50, with an external interface 240 (ES6) to the network operator 40.

Via the interface 140 (ES2+) between the network operator 40 and the profile provision entity 10 (SM-DP+), the network operator 40 controls administrative functions according to GSMA standard SGP.21, and reserves profiles 80 for embedded identification modules 70 (eUICC).

Via the interface 240 (ES6) between the network operator 40 and the embedded identification module 70 (eUICC), the network operator 40 administers profile content, using OTA services.

Via the logic interface 100, 150 (ES8+), which is provided between the first assistance module 72 IPAe and the profile provision entity 10 (SM-DP+), and between the second assistance module 52 IPAd and the profile provision entity 10 (SM-DP+), a secure end-to-end connection is configured for the administration of profile domains 76 (ISD-P), and of the profiles which are saved therein, during downloading and installation.

Via the interface 120 (ES9+) between the profile provision entity 10 (SM-DP+) and the second assistance module 52 (IPAd), a secure transmission of profile packets is executed, for example in the form of bound profile packages.

The secure transmission of profile packets is executed via the interface 110 (ES9+′) between the profile provision entity 10 (SM-DP+) and the remote management unit 20 (eIM). The remote management unit 20 (eIM) operates on behalf of the first assistance module 72 (IPAe).

Via the interface 220 (ES10a) between the second assistance module 52 (LPAd) and the embedded identification module 70 (eUICC), the second assistance module 52 (IPAd) receives configured addresses for the intermediate server 30 (SM-DS) and, optionally, for the profile provision entity 10 (SM-DP+). Via the interface 220 (ES10a), the second assistance module 52 (IPAd) transmits profile packets (bound profile packages) to the embedded identification module 70 (eUICC).

Via the interface 160 (ES11) between the intermediate server 30 (SM-DS) and the first assistance module 72 (IPAe), the first assistance module 72 (IPAe) can retrieve event data records for the embedded identification module 70 (eUICC).

Via the interface 180 (ES11′) between the remote management unit 20 (eIM) and the intermediate server 30 (SM-DS), the remote management unit 20 (eIM) retrieves event data records for the respective embedded identification module 70 (eUICC). The remote management unit 20 (eIM) can operate on behalf of the first assistance module 72 (IPAe).

Via the interface 130 (ES12) between the profile provision entity 10 (SM-DP+) and the intermediate server 30 (SM-DS), the profile provision entity 10 generates or removes event registrations on the intermediate server 30 (SM-DS).

The logic interface 210 (ESpsmo) enables a secure end-to-end communication between the remote management unit 20 (eIM) and the embedded identification module 70 (eUICC), and is employed for the transmission of profile management actions (PSMO).

Via the logic interface 190 (ESipa), the remote management unit 20 (eIM) communicates with the first assistance module 72 (IPAe). The embedded identification module 70 (eUICC) is adapted to support the interface 190. The interface 190 enables a secure end-to-end connection between the remote management unit 20 (eIM) and the embedded identification module 70 (eUICC).

By means of the interface 190, the remote management unit 20 (eIM) controls profile management actions. The remote management unit 20 (eIM) thus communicates with the first assistance module 72 (IPAe) in the embedded identification module 70 (eUICC) at all times. Via the interface 190, the remote management unit 20 (eIM) can initiate the loading of a profile 80. Profile status actions (PSMO) are also executed via the interface 190.

Loading of a profile is executed, wherein a profile 80 is provided in the profile provision entity 10 (SM-DP+) and, by means of the architecture, is transmitted to the secure domain 78 (MNO-SD) of the network operator.

Modification of a profile 80 which is loaded in an embedded identification module (eUICC) is executed by means of profile status actions (PSMO). Profile status actions can comprise, in particular, the activation of a profile, the deactivation of a profile, the deletion of a profile, the listing of profile information, the outputting of profile metadata, or the updating of a profile.

The two assistance modules 52, 72 (IPAd, IPAe) are operated such that, at the same time, only either the first assistance module 72 or the second assistance module 52 is active. If the first assistance module 72 (IPAe) is active and the second assistance module 52 (IPAd) is deactivated, a first operating mode is thus constituted. If the second assistance module 52 (IPAd) is activated and the first assistance module 72 (IPAe) is deactivated, a second operating mode is thus constituted. Which assistance module is activated and which operating mode is engaged depends upon the type of profile management action to be executed.

The first assistance module 72 (IPAe) is activated upon the reception by the latter of a profile management action from the remote management unit 20 (eIM). Profile management actions are the loading of profiles and the modification of profiles by a profile status action.

If a profile management action is a profile status action which involves a modification of the status (PSMO) of a telecommunications profile 80 which is saved in the embedded identification module (eUICC), the first assistance module 72 (IPAe) initiates the execution thereof by the embedded identification module 70 (eUICC).

Further to the execution of a profile status action, the first assistance module 72 (IPAe) transmits an acknowledgement of execution to the remote management unit 20 (eIM), wherein the transmission of this acknowledgement is executed by means of a first protocol, preferably by means of an ESPSMO protocol, e.g. a MQTT or a lightweight M2M protocol.

If a profile management action transmitted to the first assistance module 72 (IPAe) involves the loading of a new profile 80, the first assistance module 72 (IPAe) transfers the execution of the profile management action to the second assistance module 52 (IPAd). The first assistance module 72 (IPAe) is deactivated automatically, and the second assistance module 52 (IPAd) is activated.

The second assistance module 52 (IPAd) is activated, if a profile management action involves the loading of a new profile (profile download). The execution of this profile management action is then initiated by means thereof.

The second assistance module 52 (IPAd) is appropriately activated, at least until such time as a first telecommunications profile 80 has been loaded in the embedded identification module (eUICC).

Appropriately, the first assistance module 72 (IPAc) is activated, immediately a telecommunications profile 80 has been loaded in the embedded identification module 70 (eUICC) by means of the second assistance module 52 (IPAd).

Appropriately, activation of the first or second assistance module 52 (IPAd) is executed in response to a command generated by the remote management unit 20 (eIM).

By the interaction of the assistance modules 52, 72, or by the engagement of the first or second operating mode, profile management actions are effectively executed.

A profile management action can be a profile status action, by means of which the status of a profile 80 which is saved in the embedded identification module 70 (eUICC) is modified. For example, an activated profile 80 is deactivated and another is activated, or a deactivated profile 80 is deleted. Profile status actions are appropriately initiated by means of the remote management unit 20 (eIM). The sequence of a profile status action is represented in FIG. 2.

For the implementation of a modification which is intended by a profile status action (PSMO), the remote management unit 20, via the interface 190 (ESipa), establishes a secure connection to the first assistance module 72 (IPAc) and, via the interface 210 (ESpsmo), establishes a secure connection to the embedded identification element 70 (eUICC).

Via the secure connection 190, the remote management unit 20 (eIM) transmits a command data record, incorporating a profile management action, to the first assistance module 72 (IPAc), in step 1000. The terminal 50 assumes the first operating mode, the first assistance module 72 (IPAc) is activated, and the second assistance module 52 (IPAd) is deactivated.

The first assistance module 72 (IPAe) executes a check of the command data record, as to whether the profile management action is a profile status action, or involves the loading of a profile 80. If the profile management action is a profile status action, for example in the form of a PSMO message, the first assistance module 72 (IPAc) proceeds with the execution thereof, in step 1010, and initiates the corresponding modification of the addressed profile. For example, a switchover can be executed from a first profile to a second profile.

A profile management action, additionally, can be the loading of a profile 80 in the embedded identification element 70. FIG. 3 illustrates the signal flux associated with the loading of a profile 80 by the profile provision entity 10 (SM-DP+) into the embedded identification module 70 (eUICC). The initial set-up of a profile 80 on an embedded identification module 70 (eUICC) or the loading of a new profile 80 is preferably executed by means of the second assistance module 52 (IPAd) in the second operating mode.

In a first variant of embodiment O1, the loading of a profile 80 by the remote management unit 20 via the interface 150 (E8+) is initiated by means of the first assistance module 72 (IPAc). The remote management unit 20 (IM) transmits a command data record, incorporating a loading message, to the first assistance module 72 (IPAc), in step 1100. The first assistance module 72 (IPAc), by means of an activation message, activates the second assistance module (IPAd) 52, in step 1110, and deactivates automatically. The second assistance module 52 (IPAd) contacts the remote management unit 20 (eIM) via the side interface 170, and requests an activation code, in step 1120. The remote management unit 20 (eIM) transmits the activation code, in step 1130.

From the activation code, the second assistance module 52 (IPAd) ascertains the competent profile provision entity 10 (SM-DP+), and establishes a secure connection thereto via the interface 120 (S9+). The second assistance module 52 (IPAd) presents the activation code to the profile provision entity (SM-DP+), in step 1400. Further to the execution of a reciprocal authentication with the embedded identification module 70 (eUICC), the profile provision entity 10 (SM-DP+) delivers a profile packet to the second assistance module 52 (IPAd), in step 1410. The profile packet is loaded by the second assistance module 52 (IPAd) in the embedded identification module 70 (eUICC), in step 1420. The profile 80 contained in the profile packet is installed by the embedded identification module 70 (eUICC).

According to one variant of embodiment vis-à-vis O1, the remote management unit 20 (eIM) initiates the loading of a profile 80 by the activation of the intermediate server 30 (SM-DS). To this end, via the interface 190 (ESipa), a secure connection is established between the remote management unit 20 and the first assistance module 52 (IPAc). The second assistance module 52 (IPAd) is deactivated, such that the first operating mode is engaged. The first assistance module 72 (IPAc), further to reciprocal authentication by reference to an element of information which is received by the embedded identification module 70 (eUICC), via the interface 160 (E11), initiates the establishment of a secure connection to an intermediate server 30 (SM-DS), in order to retrieve an event data record from the latter. By means of the event data record, the first assistance module 72 (IPAc) identifies the competent profile provision entity 10 (SM-DP+), and executes notification thereof to the second assistance module 72 (IPAd). To this end, the second operating mode is engaged, wherein automatic deactivation is executed, and the second assistance module 52 (IPAd) is activated. The second assistance module 52 (IPAd), as described, then loads a profile into the embedded identification module 70 (eUICC).

According to a modification of this variant of embodiment, the remote management unit 20 (eIM) assumes the request for the event data record, and executes the relaying thereof to the first assistance module 52 (IPAc).

In a second variant of embodiment O2, the loading process by the remote management unit 20 (eIM) is initiated by means of an activation code which is delivered to the remote management unit 20. The remote management unit 20 (eIM), via the interface 210 (EPpsmo), transmits a message containing the activation code to the first assistance module 72 (IPAc), in step 1200. The first assistance module 72 identifies the message as a request for the loading of a profile and, by means of an activation message containing the activation code, activates the second assistance module 52, in step 1210. The terminal 50 then assumes the second operating mode.

From the activation code, the second assistance module 52 (IPAd) ascertains the competent profile provision entity 10 (SM-DP+) and, via the interface 120 (S9+), establishes a secure connection thereto. The activation code is presented by the second assistance module 52 (IPAd) to the profile provision entity (SM-DP+), in step 1400. Further to the execution of a reciprocal authentication with the embedded identification module 70 (eUICC), the profile provision entity 10 (SM-DP+) delivers a profile packet to the second assistance module 52 (IPAd), in step 1410. The profile packet is loaded by the second assistance module 52 (IPAd) in the embedded identification module 70 (eUICC), in step 1420. The profile 80 contained in the profile packet is installed by the embedded identification module 70 (eUICC).

The remote management unit 20 (eIM) and the profile provision entity 10 (SM-DP+) are notified of the successful profile set-up.

According to a modification of this variant of embodiment, a profile provision entity 10 (SM-DP+) is preset, and the ascertainment thereof from an activation code is omitted.

According to one variant of embodiment vis-à-vis O2, the loading process is initiated by the remote management unit 20 (eIM) by means of an activation code which is delivered to the remote management unit 20. Loading is executed in the first operating mode, i.e. the first assistance module 72 (IPAc) is activated, and the second assistance module 52 (IPAd) is deactivated. The remote management unit 20 (eIM), via the interface 190 (ESipa), establishes a secure connection to the first assistance module 72 (IPAe), ascertains the profile provision entity 10 (SM-DP+) from the activation code, and likewise establishes a secure connection thereto via the interface 100 (ES8+). The profile provision entity 10 (SM-DP+), via the resulting secure end-to-end connection, executes a reciprocal authentication with the embedded identification module 70 (eUICC). The profile provision entity 10 (SM-DP+) then supplies a profile packet, and executes the transmission thereof to the remote management unit 20 (eIM). The latter engages the second operating mode and, by means of the second assistance module 52 (IPAd), relays the profile packet to the embedded identification module 70 (eUICC), which installs the profile 80 and notifies the remote management unit 20 (eIM) and the profile provision entity 10 (SM-DP+) to this effect.

In a third variant of embodiment O3, the second assistance module 52 (IPAd) initiates the loading process, by establishing that a condition for the loading of a profile 80 is fulfilled, in step 1300. The second assistance module 52 (IPAd), via the side interface 170, contacts the remote management unit 20 (eIM) and requests an activation code, in step 1310. The remote management unit 20 (eIM) transmits the activation code via the side interface 170, in step 1320.

From the activation code, the second assistance module 52 (IPAd) ascertains the competent profile provision entity 10 (SM-DP+) and, via the interface 120 (S9+), establishes a secure connection thereto. The activation code is presented by the second assistance module 52 (IPAd) to the profile provision entity (SM-DP+), in step 1400. Further to the execution of a reciprocal authentication with the embedded identification module 70 (eUICC), the profile provision entity 10 delivers a profile packet to the second assistance module 52 (IPAd), in step 1410. The profile packet is loaded by the second assistance module 52 (IPAd) into the embedded identification module 70 (eUICC), in step 1420. The profile 80 contained in the profile packet is installed by the embedded identification module 70 (eUICC).

The remote management unit 20 (eIM) and the profile provision entity 10 (SM-DP+) are notified of the successful profile set-up.

According to an appropriate further development of the solution, within the terminal 50 or in the embedded identification module 70 (eUICC), an application is executed which controls the status of profiles 80 which are saved in the embedded identification module 70 (eUICC). An application of this type can be, for example, an application which identifies the present location of a terminal 50, and engages a profile 80 which is appropriate to the location. If appropriate conditions are in force, the application transmits a message to the first assistance module 72 (IPAe) which, in turn, executes the modification of the profile status.

According to a further development of the solution described, the remote management unit 20 (eIM) is configured to supply a repair profile which, if required, is loaded in an embedded identification module 70 (eUICC). Loading of the repair profile is executed as described above.

According to another further development, it is provided that, in principle, only a first assistance module 72 (IPAe) is provided in the terminal 50, and the set-up of the second assistance module 52 (IPAd) is only executed in response to the first demand for the loading of a profile 80.

In compliance with the fundamental concept for the provision of a first assistance module 72 and a second assistance module 52 for the execution of profile management actions, one of which is embodied in an embedded identification module 70 and the other in a terminal 50, wherein the first assistance module 72 initiates the execution of a profile status action, in the event that a profile status action is involved, and wherein the second assistance module 52 initiates the execution of a profile management action, in the event that the loading of a profile is included therein, the solution described incorporates a series of variations which, in the interests of clarity, are not described in greater detail. The initiation of a profile management action can thus be executed in response to the occurrence of further potential events. For example, additional measures can be provided for the protection of communications or, optionally, fewer measures can also be provided.

1-14. (canceled)

15. A terminal with an embedded identification module, which is designed to execute profile management actions, by means of which a telecommunications profile which is saved in the embedded identification module can be modified, or a new telecommunications profile can be loaded,
wherein the embedded identification module comprises a first assistance module, which provides a first interface with a remote management unit,
and the terminal comprises a second assistance module, which is connected to the embedded identification module and which provides a second interface with a profile provision entity,
wherein, at the same time, either the first assistance module or the second assistance module is active,
wherein the terminal receives command data records from the remote management unit which contain profile management actions,
wherein the first assistance module is active and initiates the execution of a profile management action, if the profile management action involves a modification of the status of a telecommunications profile which is saved in the embedded identification module, and
wherein the second assistance module is active and initiates the execution of a profile management action, in the event that the latter involves the loading of a new profile.

16. The terminal according to claim 15, wherein command data records incorporating profile management actions are transmitted via the interface and received in the first assistance module.

17. The terminal according to claim 15, wherein the second assistance module is designed to execute a data exchange with the profile provision entity, in order to load a new profile into the embedded identification module.

18. The terminal according to claim 15, wherein the first assistance module transfers the execution of a profile management action to the second assistance module, in the event that the profile management action involves the loading of a telecommunications profile.

19. The terminal according to claim 15, wherein the first assistance module, further to the execution of a profile management action, transmits an acknowledgement of execution to the remote management unit.

20. The terminal according to claim 15, wherein the second assistance module comprises a side interface to the remote management unit, which enables the request for an activation code from the remote management unit.

21. The terminal according to claim 15, wherein communication between the first assistance module and the remote management unit is executed by means of a first protocol.

22. The terminal according to claim 15, wherein communication between the second assistance module and the profile provision entity is executed by means of a second protocol.

23. The terminal according to claim 15, wherein the second assistance module is activated until such time as a first telecommunications profile has been loaded in the embedded identification module.

24. The terminal according to claim 15, wherein the first assistance module is activated, immediately a telecommunications profile has been loaded in the embedded identification module by means of the second assistance module.

25. The terminal according to claim 15, wherein activation of the first assistance module or of the second assistance module is executed in response to a command generated by the remote management unit.

26. A method for managing a telecommunications profile in an embedded identification module of a terminal by means of profile management actions, comprising the following steps:
set-up of a first assistance module in the identification module, wherein the first assistance module provides an interface to a remote management unit,
set-up of a second assistance module in the terminal, wherein the second assistance module is connected to the identification module and provides an interface to a profile provision entity,
set-up of a first operating mode, in which the first assistance module is activated and the second assistance module is deactivated,
set-up of a second operating mode, in which the second assistance module is activated and the first assistance module is deactivated,
transmission of a command data record, which contains a profile management action, from the remote management unit to the terminal,
execution of the profile management action by the first assistance module in the first operating mode, in the event that the profile management action involves a modification of the status of a telecommunications profile which is saved in the embedded identification module,
engagement of the second operating mode and execution of the profile management action by the second assistance module, in the event that the profile management action involves the loading of a new profile.

27. The method according to claim 26, wherein command data records, which contain a profile management action, are received in the first assistance module, and a profile management action is transferred to the second assistance module and the second operating mode is engaged, in the event that the profile management action involves the loading of a new telecommunications profile.

28. The method according to claim 26, wherein the command data records are generated in the remote management unit in response to incoming requests via a user interface.
